(19) United States
(12) Patent Application Publication
(10) Pub. No.: US 2005/0049028 A1
(43) Pub. Date: Mar. 3, 2005

(54) Gaming machine with extendable graphical displays

(76) Inventors: Benjamin T. Gornez, Chicago, IL (US); Joel R. Jaffe, Evanston, IL (US)

Correspondence Address: JENKENS & GILCHRIST, P.C., 225 WEST WASHINGTON, SUITE 2600, CHICAGO, IL, 60606, US

(21) Appl. No.: 10/649,928

(22) Filed: Aug. 27, 2003

(51) Int. Cl. A63F 13/00

(52) U.S. Cl. 463/20

(57) ABSTRACT

A gaming machine with an improved game display is disclosed. An extendable display is hidden by an obstruction until an event occurs in the game play that causes the extendable display to extend from behind the obstruction into the player's field of vision. The extendable display shows indicium related to the game play such as the award credits, multipliers, game terminators, additional picks, or any other type of player information. Multiple extendable displays may be hidden behind a single obstruction and selected for display by the gaming machine's CPU, the player, or a combination of the player and the gaming machine's CPU.

### FIELD OF THE INVENTION

The present invention relates to gaming machines and, more particularly, to a method and apparatus for giving a user intermittently viewable graphical information.

### BACKGROUND OF THE INVENTION

Gaming machines, such as slot machines, video gaming machines and the like, have been cornerstones of the gaming industry for many years. A gaming machine conducts a wagering game in which a random outcome is determined and displayed to a player. The random outcome is determined by a random number generator in conjunction with a probability table that includes all possible game outcomes. The player receives an award if the selected outcome is listed on the pay table (the pay table lists the award associated with each winning outcome). If the selected outcome is not on the pay table, the player loses his wager. One type of gaming machine uses arrays of symbols to present the game outcome to the player. Mechanical slots or video gaming machines typically exemplify these types of gaming machines. For each spin, the reels are rotated and randomly stopped to place the symbols on the reels in visual association with a display area.

Generally, the popularity of gaming machines is dependent on the likelihood (or perceived likelihood) of winning money at the machine and the intrinsic entertainment value of the machine. The payback percentage that each gaming machine is programmed to provide is tightly controlled by regulatory authorities. Consequently, often the only distinguishing feature between gaming machines is the entertainment value they provide. Gaming establishments strive to place the most entertaining gaming machines on their casino floors to attract players and increase profitability. In the competitive gaming machine industry there is a continuing need for gaming machine manufacturers to produce new and more entertaining types of games.

One concept that has been successfully employed to enhance the entertainment value of the gaming machine is the “bonus” game. The bonus game is generally mounted in a top box on top of the base game cabinet and is played in conjunction with the “base” game. The bonus game may comprise any type of game, either similar or completely different from the base game, and is triggered upon the occurrence of a selected event or outcome in the base game. The base game is usually a slot type machine.

The bonus game is triggered by certain predetermined base game outcomes. The bonus game typically acts as a reward for achieving certain winning outcomes in the base game. In this capacity, the bonus game typically does not require a further wager; players are usually only allowed to win credits. The player is allowed to play the bonus game, collecting as many credits as possible, before being exited from the bonus back to the base game.

Many bonus games have a selection feature that allows players to make random selections from a plurality of selectable outcomes. The player selectable outcomes are hidden until selected by the player and then revealed. The bonus game may be ended in any number of ways. The bonus game may end after the player has made a fixed number of selections, after a maximum award has been credited to the player, after a specified time limit, or after a player has selected a choice that exits the player from the bonus game. Similar to the base game, the bonus game also randomly selects a game outcome. The principal difference between the base game and the bonus game is that the base game requires a wager, whereas the bonus game does not require a wager. The bonus game is an incentive and reward for playing the base game and is often elaborately themed for maximum entertainment value.

The bonus game concept has been extremely successful because players are attracted to the enhanced entertainment value it provides. Providing an attractive and interesting game display for the gaming machine is one of the most effective methods for increasing player entertainment value. Consequently, any improved game display can provide a substantial increase in player entertainment value and an attendant increase in gaming machine revenues for the gaming establishment. Because such games are attractive to both players and operators, there is a continuing need to develop new and more entertaining features.

Although many gaming machines in the prior art use electronics and electronic game displays, few offer electromechanical devices. Many players trust and prefer electromechanical gaming machines because they feel the game outcomes are truly random. What is needed is a new electromechanical method and apparatus for selecting and presenting game outcomes to players.

### SUMMARY OF THE INVENTION

The present invention is directed toward giving players more visually interesting and entertaining gaming machine game displays. To accomplish this objective, the present invention provides intermittently viewable displays. These displays are extended into the player's field of view from behind an obstruction. Later, after the player has viewed the display, it may be retracted back out of the player's field of view behind the obstruction.

A gaming machine may have several obstructions, each obstruction hiding a plurality of extendable displays. Generally, the gaming machine's top box, because of its ample space, provides one of the most desirable locations for placing the extendable displays.

The extendable displays are initially hidden from the player's field of view behind an obstruction. Only when signaled by the gaming machine's CPU is the extendable display deployed. The CPU may send this signal based on player input, the game outcome, or a combination of both a player input and the game outcome. The deployed display may be selected by the player, randomly selected by the CPU, or both the player and the CPU may determine the display to be deployed. For example, a player may select from several different obstructions to reveal a single extendable display from behind the selected obstruction. Alternatively, the gaming machine may randomly select an extendable display from behind any of the obstructions to display to the player. Alternatively, both the player and the gaming machine may participate in the selection process; the player selects the obstruction, and the gaming machine subsequently determines one of the plurality of extendable displays behind that selected obstruction to display. Once the selection has been made, the extendable display is translated into the player's field of vision.

The extendable display may be linearly translated, rotated, or moved in any other manner from behind the obstruction to reveal the indicia on the extendable display. Any number of different drive mechanisms may be used to perform this deployment. The prime mover for the drive mechanism may be an electric motor (e.g., a stepper motor), a solenoid (to provide direct linear movement of the extendable display), or any other electromechanical device that can provide a driving force. Many different types of transmissions can couple the prime mover to the extendable display. These transmissions may include gear trains, drive members, belts and pulleys, etc.

Once the extendable display has been completely positioned in the player's field of view, the player can see the indicium on the display. The indicium displayed relates to game play and can include credits, multipliers, bonus game terminators, free plays, or any other game information.

The extendable display may be displayed in conjunction with an audio accompaniment to notify the player that an extendable display is about to be revealed. The momentary lag between finding the deployed extendable display and recognizing the game outcome increases the player's anticipation, and creates excitement through the sudden and random appearance of the extendable display.

### BRIEF DESCRIPTION OF THE DRAWINGS

The foregoing and other advantages of the invention will become apparent on reading the following detailed description and referring to the drawings in which:

FIG. 1 is a perspective view of a typical gaming machine that may include the present invention.

FIG. 2 is a block diagram of a control system suitable for operating the gaming machine shown in FIG. 1.

FIG. 3 is a side orthogonal view of a rotationally translatable extendable display with a gear train drive mechanism.

FIG. 4 is a front orthogonal view of the rotationally translatable extendable display shown in FIG. 3.

FIG. 5 is a side orthogonal view of a linearly translatable extendable display with a solenoid drive mechanism.

FIG. 6 is front orthogonal view of the linearly translatable extendable display shown in FIG. 5.

FIG. 7 is a front orthogonal view of a linearly translatable scroll mechanism with rack and pinion drive mechanisms.

FIG. 8 is a gaming machine with a bonus game top box having a linearly translatable extendable display hidden behind an obstruction.

FIG. 9 is the bonus game of FIG. 8 illustrating the deployment of a linearly translatable extendable display.

FIG. 10 is the bonus game of FIG. 8 illustrating the deployment of a second linearly translatable extendable display.

FIG. 11 is a gaming machine with a bonus game top box illustrating a second embodiment of the linearly translatable extendable display located behind an obstruction.

FIG. 12 is the bonus game of FIG. 11 illustrating the deployment of a linearly translatable extendable display.

FIG. 13 is the bonus game of FIG. 11 illustrating the deployment of a second linearly translatable extendable display.

FIG. 14 is a gaming machine with a bonus game top box having a linearly translatable extendable display deployment mechanism located behind the game display.

FIG. 15 is the bonus game of FIG. 14 illustrating the deployment of a linearly translatable extendable display.

FIG. 16 is the bonus game of FIG. 14 illustrating the deployment of any second linearly translatable extendable display.

FIG. 17 is a gaming machine with a bonus game top box illustrating a second embodiment of a linearly translatable extendable display located behind the game display.

While the invention is susceptible to various modifications and alternative forms, specific embodiments have been shown by way of example in the drawings and will be described in detail. It should be understood the invention is not intended to be limited to the particular forms shown. The invention includes all modifications, equivalents, and alternatives falling within the spirit and scope of the invention as defined by the appended claims.

### DESCRIPTION OF SPECIFIC EMBODIMENTS

The description of the preferred examples is to be construed as exemplary only and does not describe every possible embodiment of the invention. Numerous alternative embodiments could be implemented, using either current technology or technology developed after the filing date of this patent, which would still fall within the scope of the claims defining the invention.

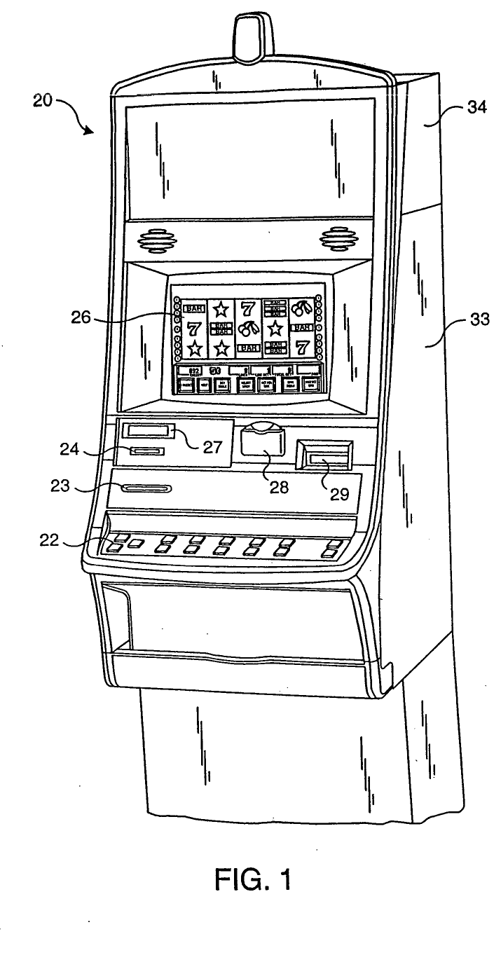

FIG. 1 is a perspective view of a typical gaming machine 20 that may be used in conjunction with the present invention. The gaming machine 20 may have varying structures and methods of operation. A gaming machine 20 may be a mechanical gaming machine configured to play mechanical slots. Similarly, gaming machine 20 may be an electromechanical gaming machine with mechanical reels having an electronically determined game outcome. Alternatively, gaming machine 20 may be entirely electronic with a game program configured to play a video casino game such as blackjack, slots, keno, bingo, poker, etc.

The gaming machine 20 shown in FIG. 1 may also include a bonus game that is typically included in a top box cabinet 34. The top box cabinet 34 is a cabinet typically located above the base game cabinet 34 with an opening to define a game display 42 for the bonus game. Similar to the base game, the bonus game may have mechanical, electromechanical, or electronic game displays. Glass may cover the top box 34 to protect the bonus game. It is in these top boxes that the present invention can be most readily adapted to function. It should be understood, however, that the present invention could just as readily be incorporated in the base game cabinet 33.

Gaming machines 20 require a variety of peripheral devices to operate. The principal peripheral components found in gaming machines are described below. It should be understood that many other components and interfaces exist and could be used in any number of combinations to create a variety of gaming machines. The number and type of peripheral devices vary depending on the options and capabilities desired for any particular gaming machine.

For example, to begin game play a wager acceptor is used to accept monetary value. The wager acceptor may include a coin slot acceptor 28 or a note acceptor 29 to enter monetary value to the gaming machine 20. A wager acceptor may also include any type of cashless gaming system.

Cashless gaming systems have been introduced to help alleviate problems associated with security and the physical transport of currency (especially coins) in gaming establishments. These systems often rely on ticket printers 23 installed in the gaming machine 20. Ticket printers 23 print or read ticket vouchers with an encoded monetary value. Players typically begin play at a gaming machine by inserting currency. When the player cashes out of the gaming machine, any remaining monetary value on the machine is encoded on a ticket, which is dispensed to the player. The player may take the ticket to a cashier and redeem it for currency. Alternatively, the ticket may be inserted into any gaming machine 20 having a ticket printer 23. The monetary value encoded on the ticket is transferred to that gaming machine 20, allowing the player to play that game.

Gaming machines 20 are also commonly equipped with a player tracking card reader 24. Player tracking cards are issued to players when they join casino loyalty programs. The player inserts the card into the gaming machine's player tracking card reader 24, which is then able to identify the player. The gaming machine 20 transmits the player's wagering activity to a central casino computer. In return for using the player tracking card, a player becomes eligible for complimentary items, services, and other special player incentives.

A push button panel 22 is typically offered to players to allow a player to interact with the various peripheral devices and with the game itself. A touch screen 21 may be installed over the game display to give players an alternative method for making game selections.

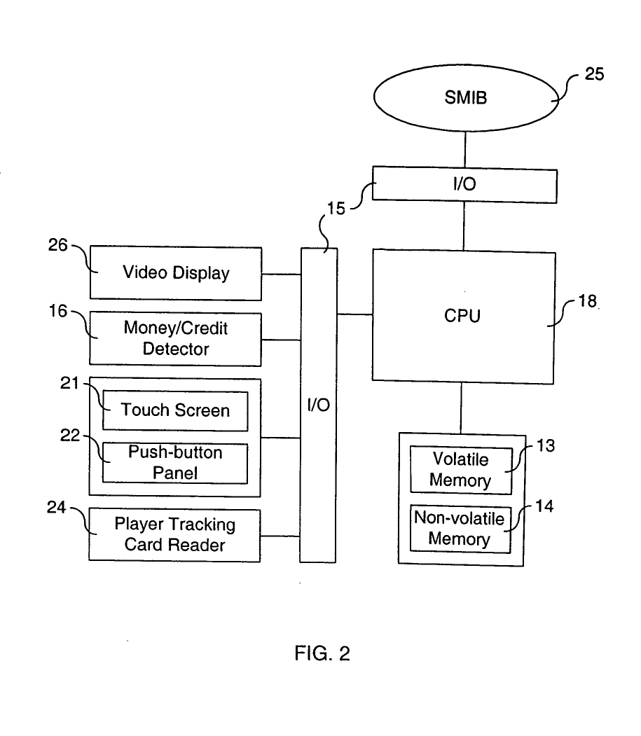

The various gaming machine peripheral devices described above are controlled by a central processing unit (CPU) 18 (e.g., a microprocessor or micro controller) as shown in FIG. 2. The CPU 18 uses a volatile memory 13 (e.g., a random-access memory (RAM)), a non-volatile memory (or static memory) 14 (e.g., an EEPROM), and an input/output (I/O) circuit 15. Although only one microprocessor is shown, the CPU 18 may include multiple microprocessors and other ancillary electronic components. These components may include video controllers, video RAM, and other miscellaneous controllers and processors. Similarly, the memory of the CPU 18 may include multiple RAM and multiple program memories. Although the I/O circuit 15 may be shown as a single block, the I/O circuit may also include many different types of I/O circuits.

Besides controlling each of the peripheral devices, the CPU 18 also executes and controls the play of the game, as well as determining the game outcome, with a game program stored in memory. The CPU 18 uses a random number generator to select a game outcome for the base game. The random number generated is compared with a probability table to decide the corresponding game outcome. The game outcome in a typical slot type gaming machine 20 is displayed to the player as a particular set of reel “stop positions.” The CPU 18 causes each reel to stop at the correct stop position.

In more sophisticated wagering games, the CPU 18 develops the game play through several intermediate game outcomes and eventually determines a final game outcome. The term game outcome will be used to refer either to a final game outcome or to an intermediate game outcome. The intermediate game outcome may or may not determine a wager outcome and could include further game play alternatives (e.g., such as free spins, game termination, multipliers, etc.).

The game itself is displayed to the player on a game display 42, such as a video game display 26, or a mechanical or electromechanical game display. The video game display 26 may be, for example, a cathode ray tube (CRT) or a flat-panel display (FPD). The video game display 26 may include a touch screen 21 overlaying the monitor to allow players to make game related selections.

In the alternative, instead of a video display, the gaming machine 20 may use a mechanical or electromechanical game display. One example of a mechanical game display 42 can be found in the first slot machines, which used several mechanical reels to display the game and its outcome. These first mechanical gaming machines were later supplanted by electromechanical gaming machines that utilize stepper motors to revolve the mechanical reels.

Although the discussion above provides examples of electromechanical and mechanical game displays related to base games, bonus games may also utilize these same types of game displays. It is in conjunction with mechanical and electromechanical game displays 42 that the present invention most readily functions, however, the present invention could be utilized in conjunction with video game displays 26 as well.

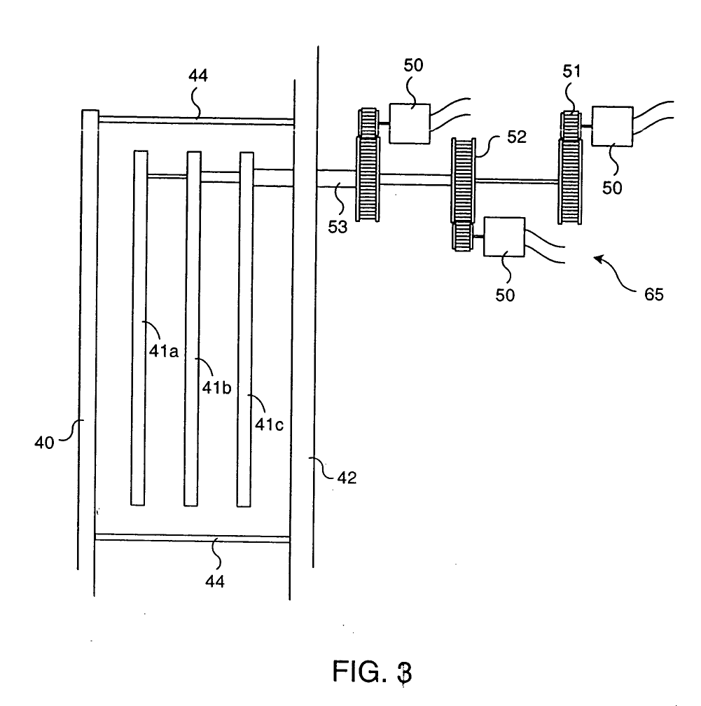

The present invention utilizes intermittently player observable extendable displays 41, shown in FIG. 3, which display an indicium 45 related to game play. FIG. 3 illustrates an extendable display 41 with a drive mechanism 65 that rotates the display into a player viewable position. Multiple extendable displays 41 are hidden by an obstruction 40 in front of a game display 42. The obstruction 40 is held in place and away from game display 42 with standoffs 44.

Once selected, the display is deployed into the player's field of view. Extendable display 41 may be rotated into position as shown, or linearly translated, revolved, or moved in any other manner from behind the obstruction 40. The present invention is most readily adaptable to the top box 34 portion of the gaming machine 20 because of the ample space available to accommodate the mechanical devices necessary for the present invention.

Each extendable display 41 may have an indicium 45 reflecting some information regarding the game. The indicium 45 may represent some type of wager outcome such as providing a credit award, or a multiplier. The indicium may even include blank displays, null symbols, neutral symbols, or even totally unrelated indicium such as artwork, designs, etc. For example, the indicia may relate to physical prizes such as cars, boats, diamonds, etc. Alternatively, the indicia may represent information related to game play such as information that progresses the game toward a conclusion. In addition, the indicium 45 may also be used to function as reel symbols to decide game outcomes. These reel symbols may be any type symbols including traditional reel symbols such as fruit, bars, and blank symbols. Yet, another way that the indicium 45 can be used is to show some form of game progress or game development. This may include indicium 45 that show free plays, wild symbols, extra choices, game terminators, player information, or any other type of informational descriptors regarding game play.

The extendable displays 41 themselves may be any type of physical device that can present an indicium 45. The extendable displays are generally hidden with an obstruction 40 until some game event initiates their deployment. The displays may be controlled by the CPU 18 and automatically deployed according to the game program stored in the CPU 18. Alternately, the player may manually select the obstruction 40 desired. A third possibility allows the player to select an obstruction 40 and the CPU 18 selects and deploys one of the plurality of extendable displays 41 hidden by the obstruction.

A number of different electromechanical drive mechanisms 65 may be used to deploy the extendable displays 41. Any prime mover and transmission may be used for the drive mechanism 65. The prime mover may be an electric motor (e.g., stepper motors), solenoids (to provide direct linear movement of the extendable display), or any other electromechanical device that can provide an actuating force. Any number of transmissions are available to convert the power from the prime mover to a displacement of the extendable display. These transmissions may include gear trains, drive members, belts and pulleys, etc. To more fully put into perspective the description provided above, a number of different embodiments in accordance with the present invention are illustrated and discussed below.

The embodiment shown in FIG. 3 utilizes a drive mechanism 65 driven by an electric motor (e.g., a stepper motor) 50 to power the deployment of the extendable displays 41. Behind the game display 42 are a series of stepper motors 50 connected to a concentric shaft 53 with a gear train having a pinion 51 and a driven gear 52. Each of the three gear trains is connected to a different concentric shaft. The concentric shafts protrude through a hole in the game display 42. Each concentric shaft 53 is individually and independently connected to one of the extendable displays 41. Instead of the gear train shown in FIG. 3, a belt and pulley transmission could be utilized.

Each motor is connected and controlled by the CPU 18. The game program stored on the CPU 18 determines which of the extendable displays 41 to deploy. The CPU 18 may signal any one of the stepper motors 50 to energize and rotate any of the extendable displays 41a, 41b, 41c into the player's field of vision. In fact, multiple extendable displays 41 may be displayed and rotated individually, or simultaneously, into position.

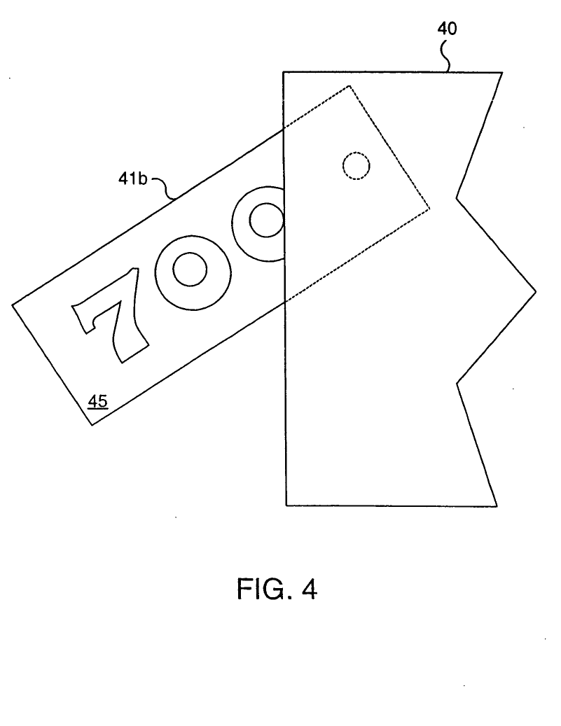

FIG. 4 illustrates the deployment of the extendable display 41. The extendable display 41a is shown in partial deployment from behind the obstruction 40. On the extendable display 41a is indicium 45 showing a 700 credit win for the player.

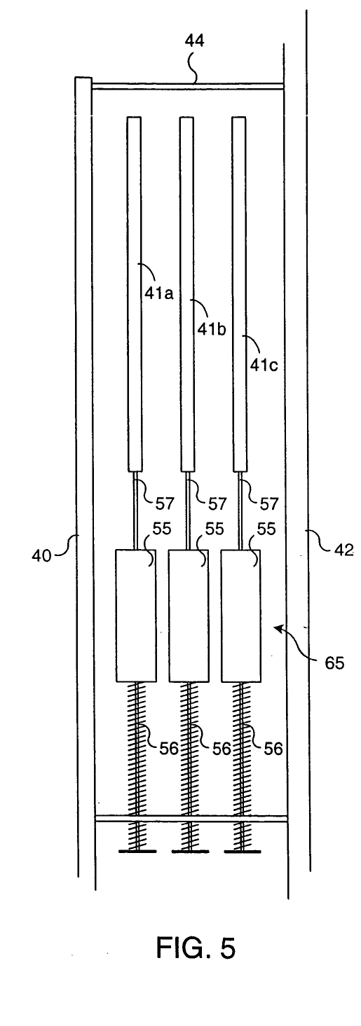

In another embodiment, a second type of drive mechanism 65 is shown in FIG. 5. This drive mechanism 65 utilizes a solenoid 55 to independently actuate and deploy the extendable display 41. Solenoid 55 may have a return spring 56 that snaps the extendable displays 41 back into their hidden position behind obstruction 40 once the solenoid 55 is de-energized.

An alternate embodiment of the solenoid drive mechanism uses a member to connect the plunger 57 to the extendable display 41. The connecting member allows the solenoid portion of the drive mechanism to be placed behind the game display 42. The member runs from behind the game display 42, through a slot, to the front of game display where it connects to the extendable display 41. The member may have any geometry necessary to connect the extendable display 41 with the plunger 57. The connecting members protrude through slots in the game display 42 that allows the members to linearly transverse and move the extendable display 41 from behind the obstruction 40. The slots are covered by the obstruction 40.

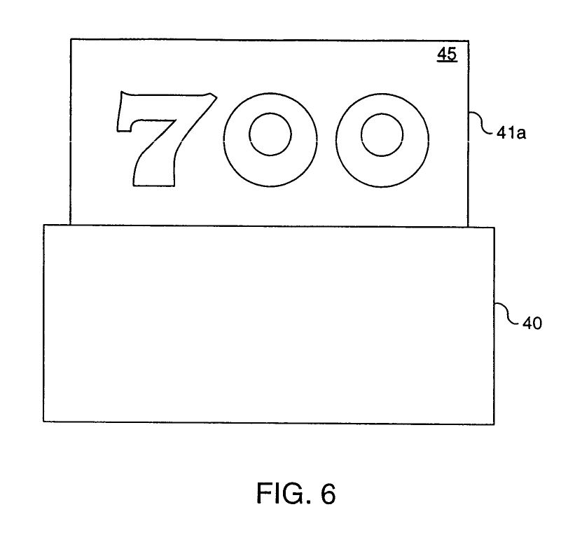

FIG. 6 illustrates the player's perspective of the linearly translatable drive mechanism with an extendable display 41 in its deployed position. The extendable display 41 appears from behind obstruction 40 with some indicium 45.

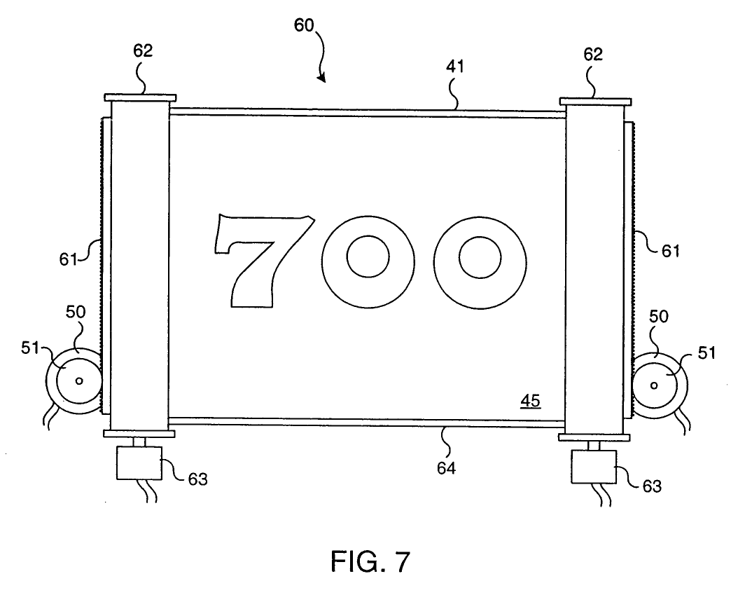

A rack and pinion drive mechanism can also be used to linearly translate the extendable display 41 as shown in FIG. 7. A carriage 64, having a rack 61 on both sides of the carriage, is engaged with and supported by a pinion gear 51. The pinion gear 51 is connected to the stepper motor 50. This entire drive mechanism 65 can be hidden behind obstruction 40 and provide the same type of linear motion obtained from the solenoid drive mechanism. The carriage 64 may be used to transport any type of physical display.

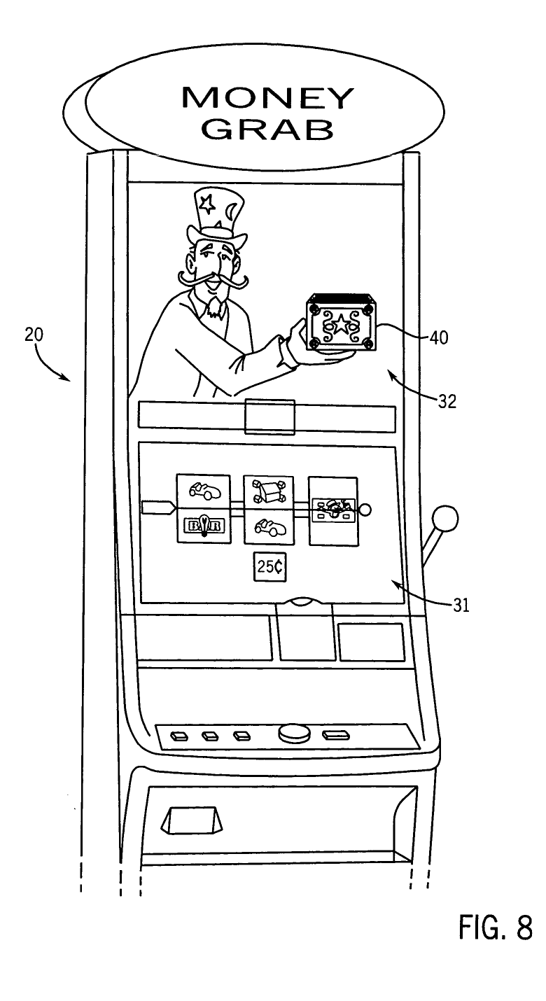

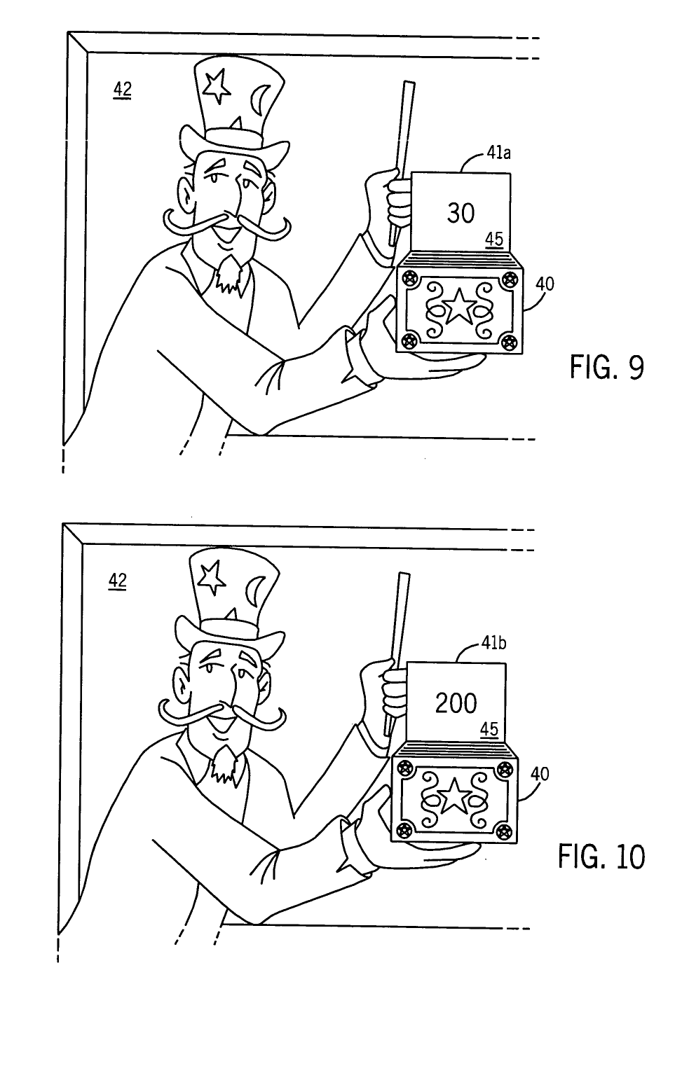

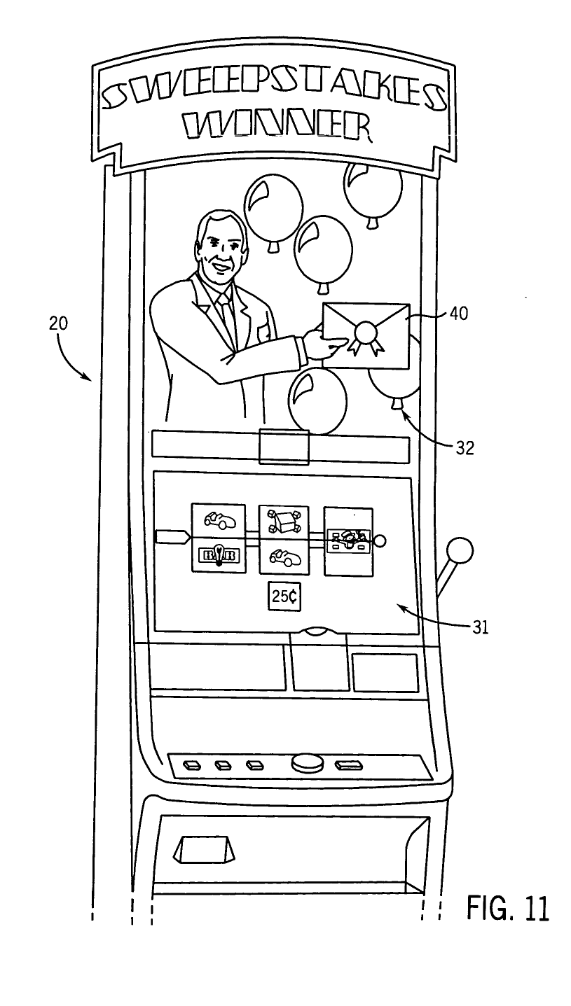

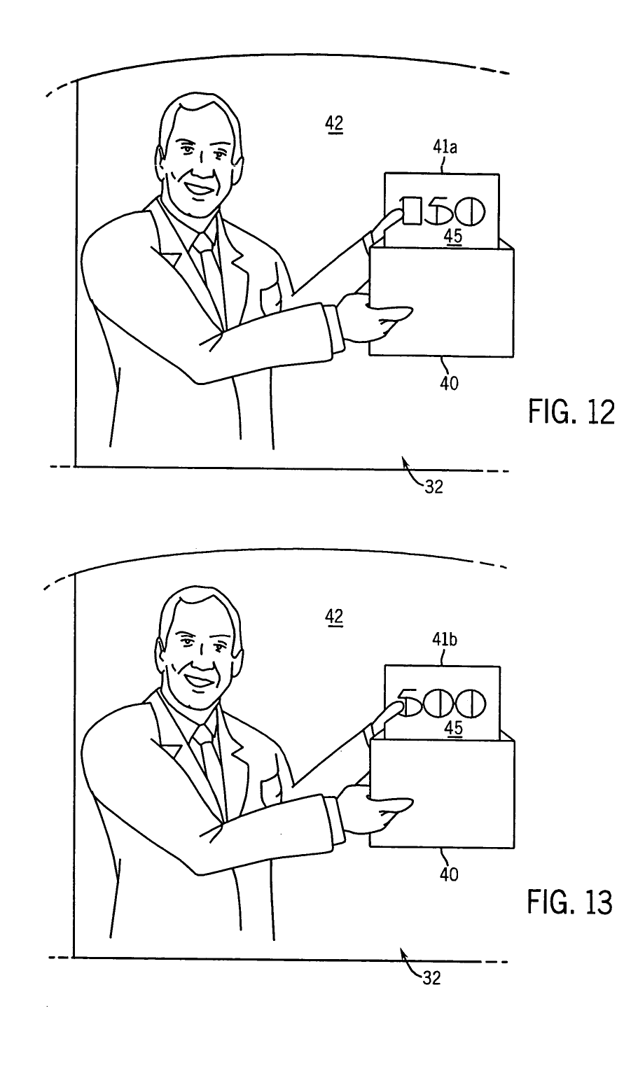

FIG. 8 illustrates how the linearly translatable drive mechanism appears to a player in a gaming machine 20. FIG. 8 depicts a gaming machine 20 having a base game 31 and a bonus game 32. The bonus game 32 shown in FIG. 8 has all the extendable displays 41 hidden by obstruction 40. FIG. 9 illustrates the bonus game 32 having a game display 42 with a deployed extendable display 41. The extendable display 41 has an indicium 45 displaying a 30 credit win to the player. FIG. 10 is a further sequence of the same game showing the bonus game 32 with a new extendable display 41 having an indicium 45 representing a 200 credit win. Similar to FIGS. 8-10, the same embodiment is shown with a different theme applied in FIGS. 11-13.

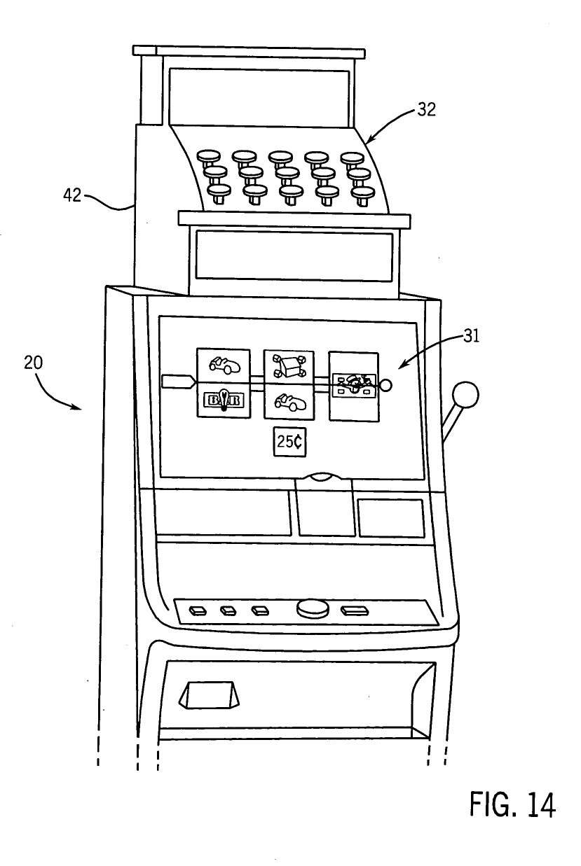

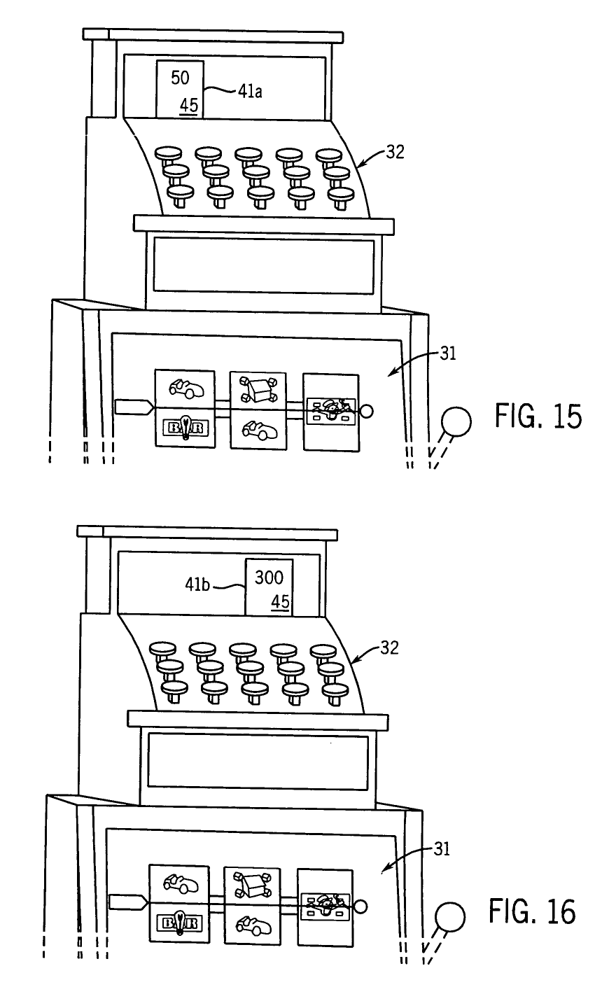

FIG. 14 illustrates how the solenoid drive mechanism may be implemented in the top box 34 of a gaming machine 20 behind the game display 42. The top box 34 containing the bonus game 32 in FIG. 14 resembles a mechanical cash register. Outcomes in the base game 31 may be translated to outcomes in the bonus game 32. FIG. 15 is the bonus game 32 of FIG. 14. The bonus game 32 is shown with an extendable display 41 valued at 50 credits. In this embodiment, the plunger 57 is located directly below the extendable display 41. When the solenoid 55 is energized, the extendable display 41 is thrust into the player's field of view. A number of extendable displays 41 may be juxtapositioned similarly to a mechanical cash register, each with their own individual solenoid 55. FIG. 16 shows the top box bonus game 32 with an extendable display 41 having a 300 credit indicium 45. Any combination of extendable displays 41 may be displayed concurrently or individually in this embodiment. In this embodiment, the game display 42 itself acts as an obstruction 40 until the extendable display 41 is activated and appears from behind the cash register.

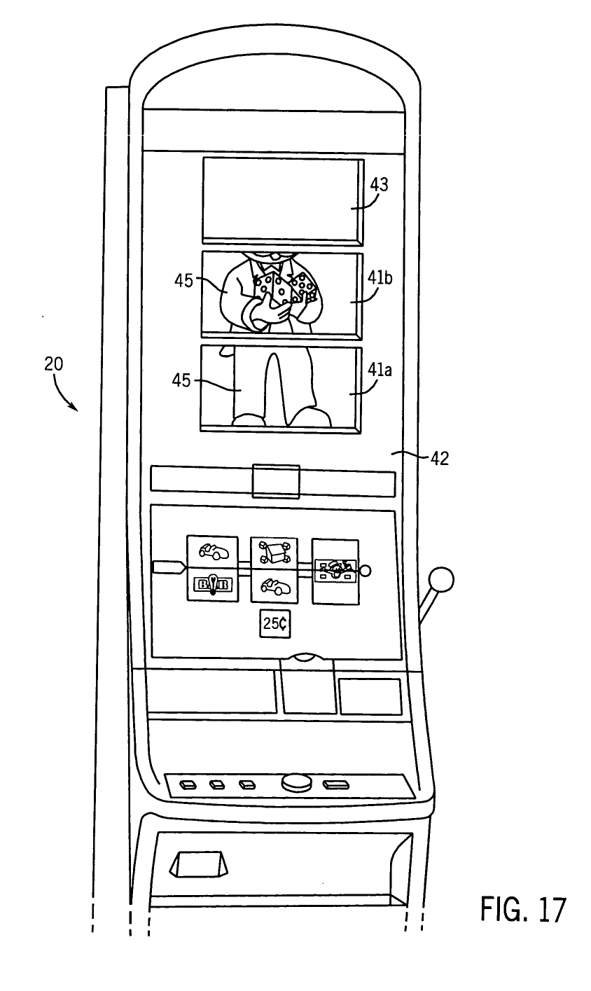

In another embodiment, the drive mechanism 65 can also be hidden behind the game display 42 as shown in FIG. 17. FIG. 17 illustrates a top box bonus game 32 in a gaming machine 20 with the extendable displays 41 located behind and appearing through the game display 42. In this embodiment, the top box game display 42 has three apertures 43 through which three separate extendable displays 41 may be displayed to the player. Each picture has its own drive mechanism 65 and potentially a plurality of different extendable displays 41 that may be shown to the player. In this game, the player is trying to assemble the partial pictures in the correct order to complete the picture. This embodiment could use any of the drive mechanisms 65 discussed above.

The extendable display 41 may take on alternate embodiments such as the scroll mechanism 60 shown in FIG. 7. In this embodiment, the scroll mechanism 60 is used to store a plurality of indicium 45 on flexible media. Each indicium 45 is separately selectable and player viewable. To select one of the plurality of indicia 45, the scroll mechanism 60 transfers the roll of media between spools 62 until the desired indicium 45 is located between the spools. This transfer is accomplished using a motor 63 on each spool 62 to take up and let down a portion of the reel until the selected indicium 45 is centered. The centered indicium 45 in the scroll mechanism 60 becomes the extendable display 41. Once the scroll mechanism 60 spool motor 63 has selected the correct indicium 45, the scroll mechanism can be translated into the player's field of view. Any number of the above drive mechanisms 65 may be used to translate the scroll mechanism 60 into the player's field of view. These drive mechanisms 65 include the rack and pinion mechanism. With the rack and pinion drive mechanism the scroll mechanism 60 can be attached directly to the carriage 64. The scroll mechanism 60 can provide a significant number of indicium 45 within a compact space.

A flat-panel display can also be used in accordance with the present invention. The flat-panel display can use a drive mechanism 65 similar to the one described above for the scroll mechanism 60. The flat-panel display may be set into a carriage driven by a rack and pinion system. The flat-panel display is in communication with the CPU 18 to allow the CPU to display images on the FPD. The video images displayed on the FPD may be static or dynamic (e.g., motion pictures or other animation). In one embodiment, the CPU 18 may provide a video data stream from the CPU to the FPD. Alternatively, the FPD may contain a memory for storing video images and the CPU 18 merely selects the image that the FPD displays. Besides the communication link, the FPD also requires a power connection. Although the FPD is in motion, the power and communication connections may be sufficiently long and flexible to allow the FPD to move freely.

All the embodiments described above involve displaying a hidden extendable display 41. Another variation can also be implemented wherein multiple extendable displays 41 may be initially extended and later retracted during game play. While initially extended all the extendable displays 41 either may be in the player's field of view or stacked in tandem. As game play progresses the extendable displays 41 are retracted heightening player anticipation until only a single extendable display 41 is left. Other variations are also possible including allowing the player to receive any of the awards listed on any of the remaining extendable displays 41 before game play ends.

While the present invention has been described with reference to one or more particular embodiments, those skilled in the art will recognize that many changes may be made thereto without departing from the spirit and scope of the present invention. Each of these embodiments and obvious variations described above is contemplated as falling within the spirit and scope of the claimed invention, which is set forth in the following claims.

1. A gaming machine having an improved game display comprising:
an extendable display having an indicium, the extendable display further having a first position in the field of view of a player and a second position out of the field of view of a player;
a drive mechanism connected to the extendable display; and
a central processing unit for signaling the drive mechanism to translate the extendable display between the first position and the second position.

2. The gaming machine as described in claim 1, wherein the game display has an aperture, the aperture for allowing the player to view the extendable display in the second position.

3. The gaming machine as described in claim 1, wherein the first position is behind an obstruction.

4. The gaming machine as described in claim 1, wherein the drive mechanism rotates the extendable display between the first position and the second position.

5. The gaming machine as described in claim 1, wherein the drive mechanism linearly translates the extendable display between the first position and the second position.

6. The gaming machine as described in claim 1, wherein the extendable display is a flat-panel display for displaying the indicium.

7. The gaming machine as described in claim 1, wherein the extendable display is a scroll mechanism having a plurality of indicia, each of the plurality of indicia individually selectable.

8. A gaming machine having an improved game display comprising:
a plurality of extendable displays each having an indicium, each of the plurality of extendable displays having a first position behind an obstruction, each of the plurality of extendable displays further having a second position observable to a player;
a drive mechanism selectably engageable to each of the plurality of extendable displays; and
a central processing unit for selecting one of the plurality of extendable displays, the central processing unit further for signaling the drive mechanism to translate the selected extendable display between the first position and the second position.

9. The gaming machine as described in claim 8, wherein the drive mechanism rotates the extendable display between the first position and the second position.

10. The gaming machine as described in claim 8, wherein the drive mechanism linearly translates the extendable display from the first position to the second position.

11. The gaming machine as described in claim 8, wherein the drive mechanism comprises:
a plurality of shafts concentrically oriented; and
a plurality of motors, each of the plurality of motors for driving one of the plurality of shafts, each of the plurality of shafts connected to at least one extendable display.

12. The gaming machine as described in claim 8, wherein the drive mechanism comprises a plurality of solenoid valves, each solenoid valve connected to one of the plurality of extendable displays, each of the plurality of solenoid valves for linearly translating the extendable display.

13. A method for providing an improved game display for a gaming machine comprising:
locating an extendable display in the game display in a first position out of the field of view of a player;
extending the extendable display to a second position in the field of view of a player with a drive mechanism controlled by a central processing unit.

14. The method described in claim 13, wherein the extendable display has an indicium.

15. The method described in claim 14, wherein the game display has an aperture aligned with the second position of the extendable display.

16. The method described in claim 14, wherein the extendable display is located behind an obstruction.

17. The method described in claim 14, wherein the drive mechanism rotates the extendable display between the first position and the second position.

18. The method described in claim 14, wherein the drive mechanism linearly translates the extendable display between the first position and the second position.

19. A method for providing an improved game display for a gaming machine comprising:
locating a plurality of extendable displays behind an obstruction in the game display, each of the plurality of extendable display having an indicium;
selecting one of the plurality of extendable displays with the central processing unit; and
signaling a drive mechanism with the central processing unit to extend the selected extendable display into the field of view of a player.

20. The method described in claim 21, further comprising determining a game outcome, wherein the game outcome determines the selected extendable display.

21. The method described in claim 21, wherein the drive mechanism rotationally translates the extendable display.

22. The method described in claim 21, wherein the drive mechanism linearly translates the extendable display.

23. A gaming machine having an improved game display comprising:
an extendable display having an indicium, the extendable display further having a first position out of the field of view of a player, the extendable display further having a second position partially in the field of view of a player, the extendable display further having a third position in the field of view of a player;
a drive mechanism connected to the extendable display; and
a central processing unit for signaling the drive mechanism to translate the extendable display from the first position to the second position, the central processing unit further for signaling the drive mechanism to translate the extendable display from the second position to the third position, whereby the player is unable to fully view the indicium until the extendable display is in the third position.
